(19) United States
(12) Patent Application Publication
(10) Pub. No.: US 2018/0208085 A1
(43) Pub. Date: Jul. 26, 2018

(54) CAR SEAT WITH RIGID BACKREST

(71) Applicant: DOREL JUVENILE GROUP, INC., Foxboro, MA (US)

(72) Inventors: Francois RENAUDIN, Cholet (FR); Nicolas GARNIER, Saint Germain Sur Moine (FR)

(21) Appl. No.: 15/549,275

(22) PCT Filed: Feb. 9, 2016
(86) PCT No.: PCT/EP2016/052664

§ 371 Date: Dec. 19, 2017

(30) Foreign Application Priority Data
Feb. 9, 2015 (FR) 1551025

(51) Int. Cl. B60N 2/28

(52) U.S. Cl. CPC B60N 2/2809; B60N 2/2851; B60N 2002/2896; B60N 2/2887; B60N 2/2872

(57) ABSTRACT

The invention relates to a child car seat (1), comprising a seat part (12) and a back-rest (11), said back-rest having a rigid back-rest structure (20), the width at the top thereof being smaller than the width of the base thereof, and a lower part of said back-rest structure (20) being hollowed-out between side posts (201, 202) and an upper part of said back-rest structure (20) having two holes (204, 205) for passing a harness strap therethrough.

### FIELD OF THE INVENTION

The field of the invention is that of child care. More precisely, the invention relates to child car seats intended to be installed on the bench seat of a motor vehicle.

Further more precisely, the invention relates to a particular architecture of such a child seat.

### PRIOR ART

The comfort and the safety of children when they are transported in a motor vehicle are important aspects in the technical development of car seats. The technical changes tend however to make the seats heavy and voluminous, and therefore difficult to manipulate.

Basically, a car seat comprises a seat base and a seat back, each constituted of a rigid structure (for example steel) covered with an additional portion made of foam (for example polyurethane foam). Most car seats intended to be fixed to a bench seat of a vehicle are provided to be robust, and thus comprise a solid and rigid seat back and seat base structures.

These structural characteristics, although they make it possible to provide relative comfort and safety, make the seat cumbersome and heavy. From this stems difficulties in installing, manipulating, and transferring the seat from one car to another. In particular, there are risks of incorrectly installing and fastening the seat on the vehicle bench seat.

The high rigidity of these structures can also give rise to problems, in particular for the absorption of energy, for example in case of a strong lateral impact.

Generally, there is a need to improve car seats according to at least two aspects that appear to be incompatible: the weight (and/or the volume) of the seat and the safety of the child.

### DISCLOSURE OF THE INVENTION

This invention has for objective to overcome these disadvantages of prior art.

These objectives, as well as others that will appear in what follows, are achieved using a child car seat, comprising a seat base and a seat back, with the latter having a rigid seat back structure of which the width at its top is less than the width of its base, and a lower portion of said seat back structure being recessed between lateral uprights, and an upper portion of said seat back structure having two holes for passing a harness strap.

It is thus possible to reduce the weight of the car seat while still increasing the effectiveness of it, in terms of safety. Indeed, such a perforated seat back structure makes it possible to substantially lighten the total weight of the seat, thus facilitating the manipulation, installation, or the displacement of the seat from one vehicle to another. Moreover, thanks to its specific shape, with the top being not as wide as the base of the seat back, this structure is more resistant to the forces of torsion and non-symmetrical loads than that of existing seats, in particular those that have a solid rectangular structure. Such forces of torsion are in particular encountered in the case of complex impacts.

According to a particular embodiment, said seat back structure has the general shape of an A, of which the lateral uprights come close to one another, from the base of said seat back to its upper end.

This coming together can be in particular obtained by implementing inclined uprights, in relation to the horizontal, over their entire length or over a portion of the latter, or by implementing uprights with several “step-shaped” elements, coming closer to one another “by pieces”, not continuously.

According to a particular approach, said upper portion extends over a height that represents between one-third and two-thirds of the total height of the seat back.

Of course, the more this height is reduced, i.e. the more substantial the recessed portion is, the more reduced the weight is.

According to a particular embodiment, said rigid seat back structure is formed from two lateral units, each comprising one of the lateral uprights and one of said holes for passing a strap, made integral by at least one reinforcing element.

This approach allows for simplified manufacture of the structure. The adding of a reinforcing element makes it possible to maintain the two units fixedly in relation to one another and to rigidify the unit. In other embodiments, and for example for a manufacture in composite materials, production in a single piece is of course possible.

According to a particular embodiment, said rigid seat back structure comprises two reinforcing elements, respectively at the upper end and at the lower end of said upper portion.

These reinforcing elements make it possible to rigidify the structure of the seat back, by providing cohesion for the unit.

At least one of said reinforcing elements can furthermore guide and/or retain a fastening strap, referred to as “top tether” strap, allowing for the attaching of an upper portion of the seat back of said seat with an anchoring point provided for this purpose in a vehicle.

This structure is indeed well suited for the implementation of a “top tether” strap that can circulate inside the seat back, with the idler located in the lower portion of the seat (for example in the seat base).

According to a particular aspect, each one of said lateral uprights can carry, at its lower end, an element for anchoring one of said straps.

According to a particular embodiment, said seat base has a rigid seat base structure in the general shape of an A, of which the lateral edges come close to one another, from its proximal end, close to the seat back, to its distal end, moved away from the seat back.

This also makes it possible to reduce the volume and the weight, while still offering better resistance to the forces of torsion.

In particular, said seat base structure can define a substantially triangular shape, recessed inside, the distal end defining a zone for anchoring a crotch support and/or a “top tether” strap idler.

According to a particular embodiment, the proximal end of said seat base structure can be included between the lower ends of the lateral edges of said seat back structure.

According to a particular technique, said rigid seat back structure and/or rigid seat base structure is made at least in part from stamped sheet metal.

This approach provides rigidity and lightness to the seat base. It is also possible to carry out these structures for example in composite or plastic material.

According to a particular embodiment of the invention, said seat base and said seat backcan have a folded position, in which said seat base is brought back against said seat back, in order to form a compact unit, and an unfolded position, wherein a child can be installed in said seat.

The folded back position of the seat, jointly with its light weight, facilitates the transport, manipulation and storage of the seat when it is not used.

In this case, the proximal end of said seat base structure can be mounted on an axis extending between the lower ends of the lateral edges of said seat back structure.

This axis constitutes the axis of rotation that allows the mobile seat base to be folded back against the seat back.

According to a particular embodiment, two clips for connecting to locations provided for this purpose in the vehicle are movably mounted in rotation at the base of said seat back, independently of one another.

Thus, the car seat can be anchored to a vehicle bench seat comprising the adapted anchoring elements. The mobility in rotation and their independence allows the clips to absorb a portion of the energy of impacts, which therefore is not fully transmitted to the seat.

According to a particular embodiment, two clips for connecting to locations provided for this purpose in the vehicle are movably mounted at the base of said seat back, between a deployed position, allowing said connection, and a storage position, in a housing provided for this purpose in said seat back.

This allows the seat to have a compact shape when it is not used and when it must be stowed/stored.

### LIST OF FIGURES

Other characteristics and advantages of the invention shall appear more clearly when reading the following description of embodiments, provided simply for the purposes of information and are non-restrictive, and of the annexed figures, among which:

FIGS. 1A and 1B are three-dimensional views of the car seat and of its underlying structure:

FIG. 1A: view of the car seat according to a particular embodiment;

FIG. 1B: view of the structure of the seat comprising a seat back structure and a seat base structure.

FIG. 2 is a front view of the seat back structure according to a particular embodiment.

FIGS. 3A, 3B, 3C and 3D show the various elements of the seat back structure:

FIG. 3A: three-dimensional view of the seat back structure;

FIG. 3B: three-dimensional view of the two lateral units;

FIG. 3C: three-dimensional view of the two lower and upper reinforcing elements;

FIG. 3D: three-dimensional view of the central reinforcing element.

FIG. 4 is a simplified diagram of the seat back structure, showing the zones for retaining the child on the car seat, and the car seat on the seat of the vehicle.

FIG. 5 is a view of the system referred to as “top tether” for fastening the car seat to a motor vehicle.

FIG. 6 shows a top view of the structure of the seat base of the car seat according to a first embodiment.

FIG. 7 shows a three-dimensional view of the structure of the seat provided with the seat base of FIG. 6.

FIG. 8 shows a three-dimensional view of the structure of the seat provided with an alternative of the seat base.

FIGS. 9A and 9B show two alternative embodiments of the structure of the seat back, respectively: stamped structure and mechanically-welded structure;

FIGS. 10A, 10B, 10C, and 10D show views of the mechanism of the connecting clips, according to an embodiment;

FIGS. 11A and 11B show the two unfolded and folded positions that the car seat can have:

FIG. 11A: unfolded position;

FIG. 11B: folded position.

FIGS. 12A, 12B, 12C and 12D show the car seat according to an alternative embodiment, wherein the axis of rotation of the seat base differs from the axis of rotation of the connecting clips, respectively:

FIG. 12A: front view;

FIG. 12B: left view;

FIG. 12C: right view;

FIG. 12D: bottom view.

### DESCRIPTION OF AN EMBODIMENT OF THE INVENTION

### General Principle

The invention relates to a new approach of the underlying structure of a child car seat, comprising a seat back and a seat base, that makes it possible to increase the safety of the child and to reduce the weight of the seat.

In particular, the invention comprises a rigid seat back structure in the general shape of an A, (which can also be likened to an “Eiffel Tower” shape), truncated at its top. This structure is characterised by lateral uprights that are not parallel, but that come closer to one another, from the base of the seat back to its upper end, and a lower recessed portion between the lateral uprights.

This approach makes it possible to provide a light structure, that requires little material, and that offers high resistance in case of impact, and in particular to torsion, in case of a lateral impact. It is thus possible to hollow out the lower portion of the seat back, between the two uprights, and therefore to substantially reduce the weight of the seat.

The upper portion of the seat back structure can also be provided with two holes for passing the straps of a safety harness.

The two lateral uprights are connected by two crosspieces, a first upper crosspiece, on the upper portion, and a second median crosspiece (corresponding to the “bar of the A”).

Such a seat structure, able to receive in particular upholstery elements used to support the child (foam linings, plastic parts, etc.), makes it possible to reduce the weight and the volume of the seat due to its perforated architecture. Moreover, this seat structure has the advantage of increasing the safety of the child installed in the seat, in particular in the cases where the seat is subjected to non-symmetrical forces, such as during lateral impacts. Indeed, such a structure, having a top end section of the seat back that is smaller than the bottom end section of the seat back, provides a resistance to torsion that is greater than solutions that implement a rectangular and/or solid structure.

### Particular Embodiment

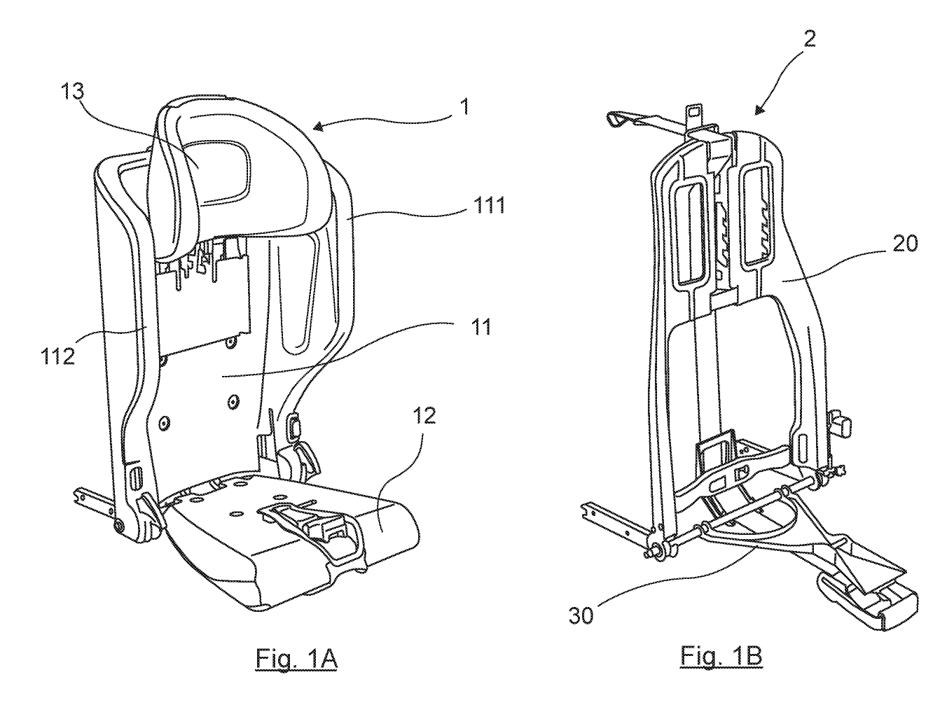

The child car seat 1 of the invention is shown in FIG. 1A. It comprises a seat back 11 provided with lateral protective walls 111, 112 and a seat base 12. In the embodiment shown, this seat base 12 is mobile in rotation in relation to the seat back 11. The invention is particularly suited for carrying out such a foldable seat. However, it also applies to seats having a fixed seat base/seat back structure.

The seat also comprises, in this embodiment, a headrest 13 that can be adjusted in height in order to be adjusted to the size and to the morphology of a child, and of which the adjustment acts on the position of the harness.

The seat back 11 and the seat base 12 are more preferably made using expanded polypropylene (“EPP”) or polypropylene (“PP”). These elements can be directly thermoformed on the rigid underlying structure 2 comprised of a seat back structure 20 and of a seat base structure 30, as shown in FIG. 1B. These seat back 20 and seat base 30 structures are for example carried out at least partially in stamped sheet metal, in composite or plastic material.

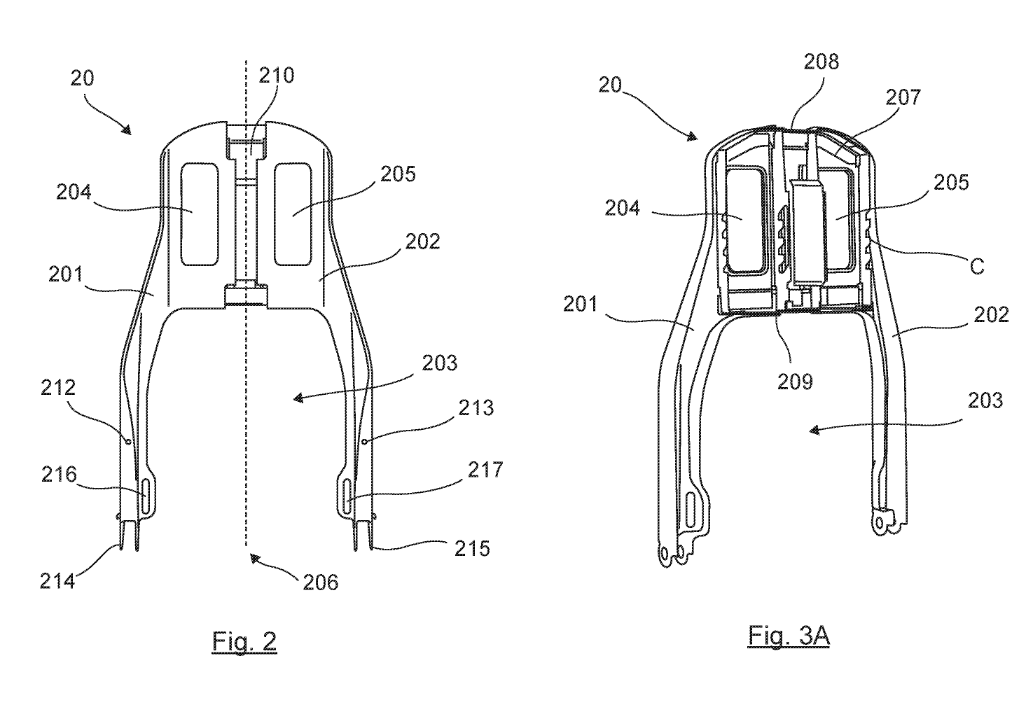

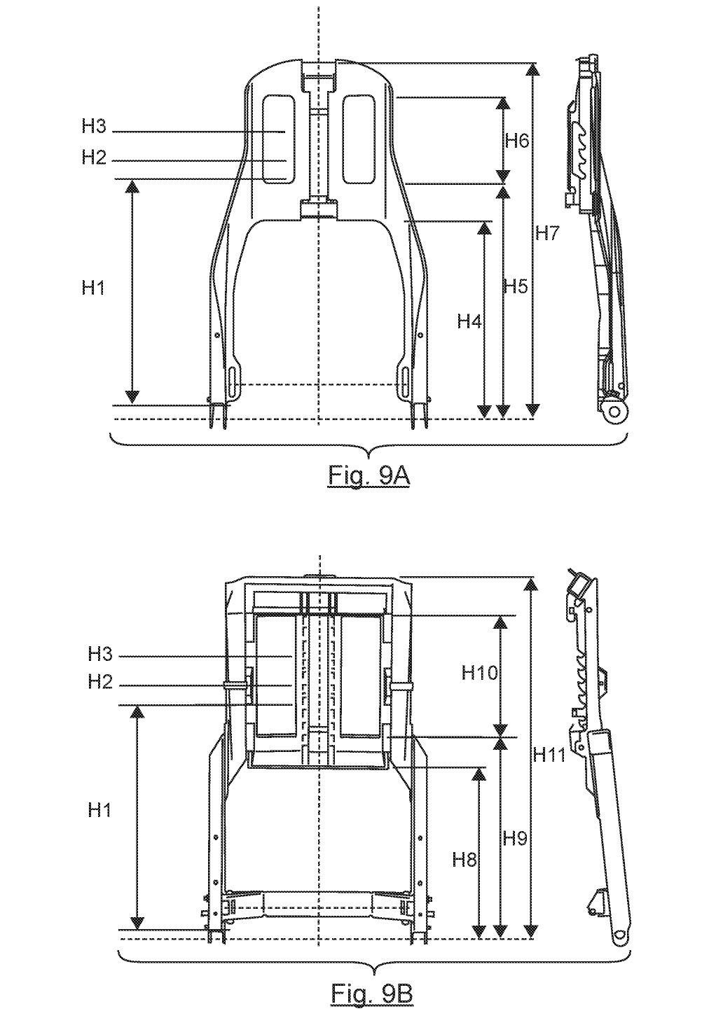

FIG. 2 and FIG. 9A show the seat back structure 20 carried out in stamped sheet metal, according to a preferred embodiment. The structure has a shape that can be likened to an A, of which the lateral uprights 201, 202 come close to one another in the upper portion of the seat back structure.

The seat back structure is formed symmetrically in relation to a vertical axis 206. The lower portion of the structure has a recess 203 between the lateral uprights 201, 202. The upper portion of the structure has two holes 204, 205 of elongated rectangular shape, suited to receive the harness straps of the car seat, as well as the headrest 13. These holes, of a length H6, substantially equal to 119 mm, are also arranged symmetrically in relation to the vertical axis 206, and globally centred in the upper portion of the structure, at a height H5 of 321 mm in relation to the seat base. H1, H2 and H3, corresponding to the dimensions 309+/−7 mm, 329+/−7 mm, and 362+/−7 mm, define three heights for adjusting the straps of the harness. The shape of the holes and their position are however not limited to the description given hereinabove. Advantageously, the seat back structure measures 486 mm in height (H7), with the recess 203 extending over a height H4 of 269 mm.

FIG. 9B shows an alternative embodiment according to which the seat back structure 20 is carried out via a method of mechanical welding. This mechanically-welded structure has dimensions that are somewhat different from the stamped steel sheet structure. The total height H11 of the structure is thus approximately 550 mm, while the height H8 of the recess defined in the lower portion is 234 mm. The holes, which have a height H10 of 160 mm, are carried out in the upper portion of the structure, at a dimension H9 that is substantially equal to 280 mm.

All of the dimensions given hereinabove are of course for the purposes of information and are not restricted, and correspond to particular embodiments that are potentially non-definitive.

Thus, the ratio between the width of the top and the width of the base is between approximately 0.4 and 0.9 (for example approximately 0.5 for the embodiment of FIG. 9A and approximately 0.9 for the embodiment of FIG. 9B). This makes it possible to confer the general shape of the seat back as a trapeze, defined by the end points of the top and of the base of the structure. This shape makes it possible to obtain good effectiveness in particular with respect to the forces of torsion, in relation to a conventional structure defining a rectangle.

The height of the bottom portion, recessed, has between ⅓ and ⅔ of the total height of the structure of the seat back, and for example approximately half of the total height, for the embodiment shown of a stamped structure, and approximately ⅖ of the total height, for the embodiment shown with a mechanically-welded structure.

The general shape of an A, perforated, of this seat back structure makes it possible on the one hand to substantially lighten the total weight of the seat, and thus to facilitate the manipulation, installation on a bench seat, the displacement of it from one car to another, i.e. more generally the transport thereof. On the other hand, this structure has the advantage of being more resistant to the forces of torsion that that of a seat that has a solid rectangular structure or in the general shape of an H. The forces of torsion, encountered in particular in the case of lateral and/or complex impacts, are characterised by non-symmetrical loads applied in particular to the seat back of the seat. The seat back structure, according to the invention, therefore makes it possible to substantially increase the safety of the child in his seat.

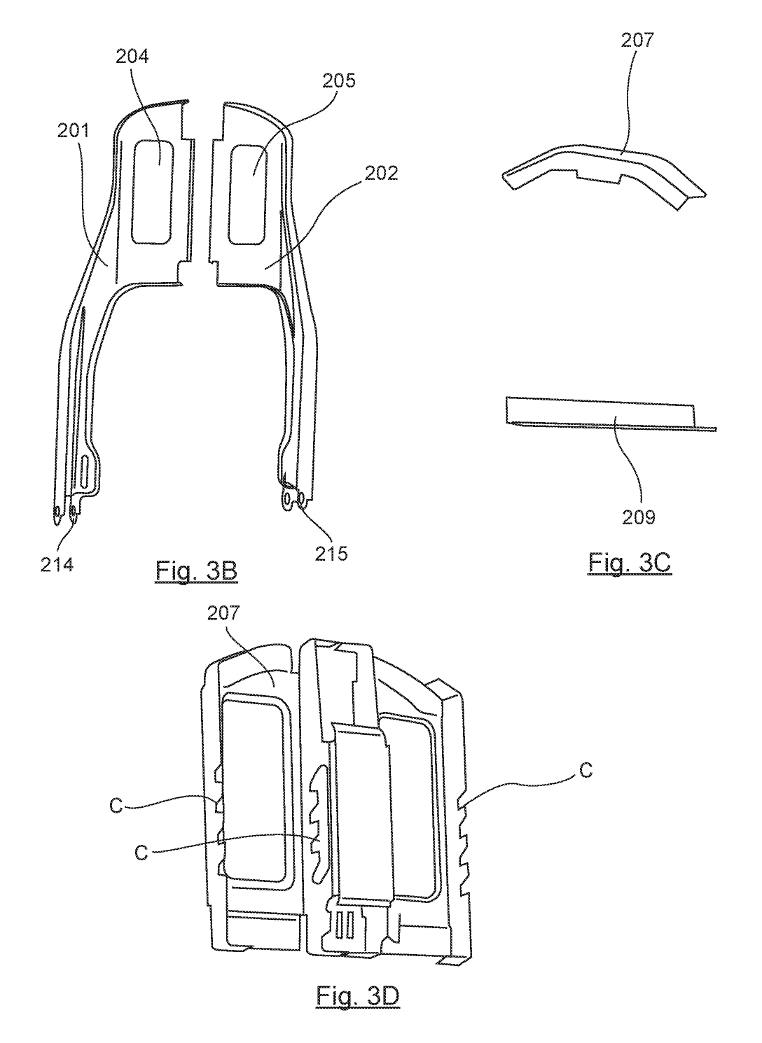

FIGS. 3A to 3D show the various elements that comprise the seat back structure 20, according to a particular embodiment. The two uprights 201, 202 and their respective hole 204, 205 each constitute a lateral unit, as shown in FIG. 3B. Carrying out the structure using two symmetrical units simplifies the manufacture of the seat (for example by stamping or mechanical welding) and the tooling required.

They are being maintained fixedly in relation to one another by means of a reinforcing element 207 having substantially the same shape as the upper portion of the structure (see FIG. 3D). This reinforcing element 207, carried out for example in stamped sheet metal or in a composite material, comprises two holes similar to the holes 204, 205 of the two uprights 201, 202. The edges of the holes are provided with a rack C with three teeth, corresponding to the three heights H1, H2, H3 for adjusting the straps of the harness. In this embodiment, the reinforcing element 207 also comprises a central protruding portion, that makes it possible to prevent contact between the “top tether” strap 218 and the headrest 13 (in this way, the tight “top tether” strap is not in contact with the rack C, and therefore does not prevent the displacement of the headrest 13 along this rack).

Two other reinforcing elements 208, 209 rigidify the seat back structure. They are placed at the upper end and at the lower end of the upper portion of the structure, between the uprights and the reinforcing element 207, as shown in FIGS. 3A and 3C. These reinforcing elements 208, 209 thus have a shape that adapts to the contours of the upper portion of the structure of the seat back.

In another embodiment, this structure can be carried out as a single unit comprising the two uprights 201, 202 and their holes 204, 205, for example in a composite material.

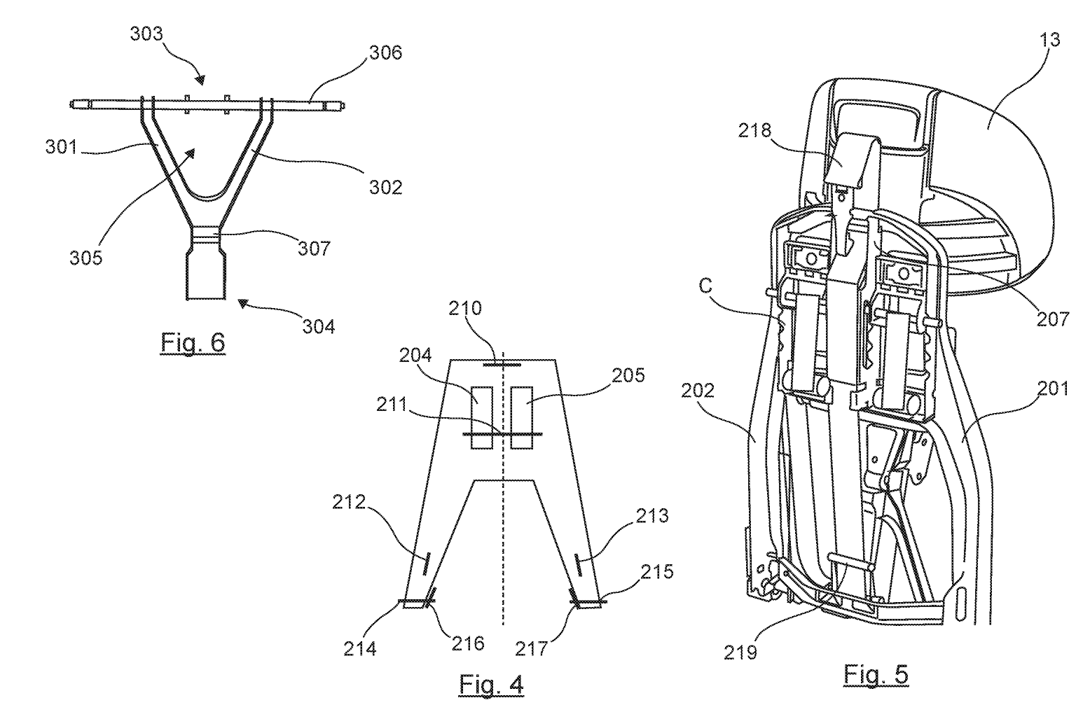

A car seat must, on the one hand, retain the child on the seat, and on the other hand, fasten the car seat to a motor vehicle bench seat. FIG. 4 diagrammatically shows a seat back structure of the car seat, according to a particular embodiment, and the various zones for retaining the child to the seat on the one hand, and of the seat to the vehicle on the other hand.

Five zones for retaining the child to the seat 211, 212, 213, 216, 217 are provided, corresponding to the anchoring points of a 5-point harness: a first zone intended for the fastening of the straps of the shoulder harness 211, two symmetrical zones intended for the fastening of the straps of the thigh harness 212, 213, and two symmetrical zones intended for the fastening of the crotch support 216, 217.

Three other zones 210, 214, 215 make it possible to link the car seat to a motor vehicle bench seat: the zone 210 receives a system referred to as “top tether” while the symmetrical zones 214, 215 are intended to receive connecting clips, for example of the ISOFIX type.

These retaining zones are also shown in FIG. 2. Of course, the aspect and the position of these zones are not limited to the representation that is made of them in this particular embodiment.

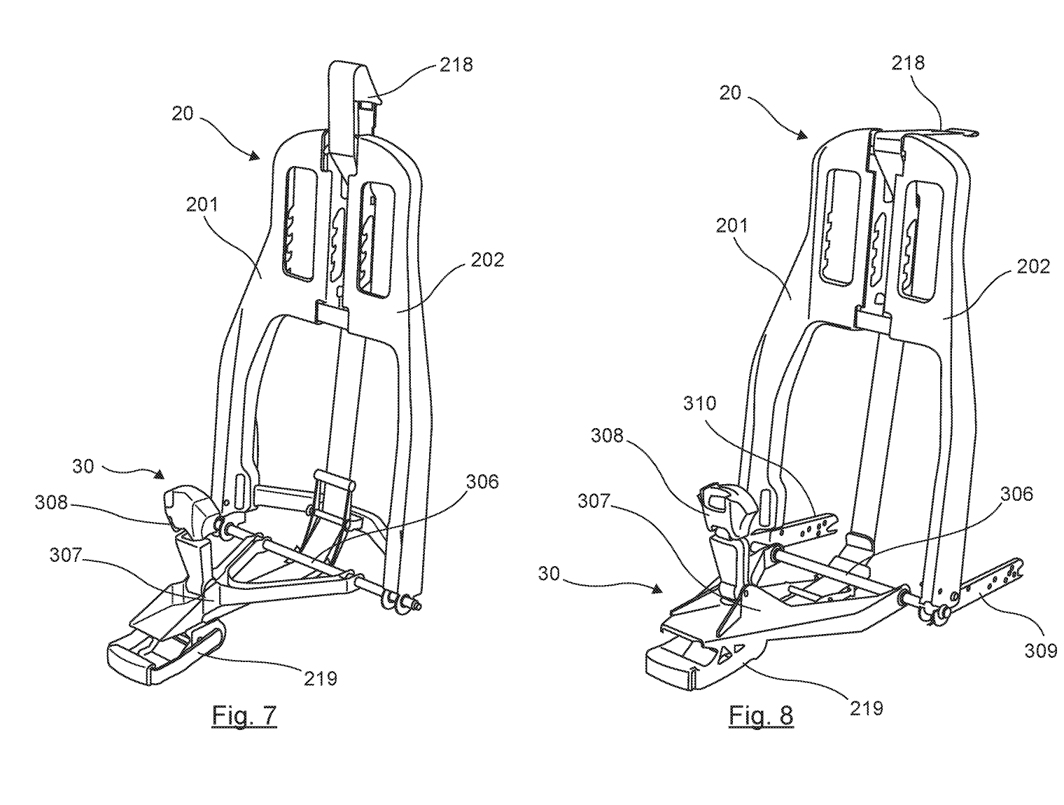

The system referred to as “top tether”, comprises a fastening strap 218, provided at its end with a hook, that makes it possible to fasten the upper portion of the seat back of the seat to an anchoring point provided for this purpose in the motor vehicle wherein it is installed. In the embodiment shown, the “top tether” strap is guided in the seat back, and is retained by a first of its ends, on the seat base, as shown in FIGS. 5 and 7.

In addition to the particular seat back structure 20, the structure of the car seat can also include a particular seat base structure 30, of which an example is shown in FIG. 6. Such a seat back structure also has the general shape of an A, which is possible to be assimilated with a substantially triangular or trapezoidal shape. The lateral edges 301, 302 of the seat back structure come close to one another, from its proximal end 303, i.e. the closest to the seat back, to its distal end 304, i.e. the farthest away from the seat back. The seat back structure comprises a recess 305 between its lateral edges 301, 302, which also has a globally triangular shape.

These characteristics again make it possible to reduce the weight of the seat back structure, and more globally of the car seat, and also to offer good resistance, in particular to torsion.

The distal end 304 of the seat back structure comprises an anchoring zone 307 for an element 308 intended, in this embodiment, to receive the attachment of a crotch support of a harness and a fastening element (and where applicable a idling element) of the “top tether” strap, that can in particular include a handle, as shown in FIGS. 7 and 8. The proximal end 303 is mounted in rotation on an axis 306 that takes position between the uprights 201, 202 of the seat back structure, in their lower portion.

In this embodiment, the axis 306 is integral with the seat base and the unit formed by the seat base and the axis is free in rotation in relation to the seat back (which makes it possible to implement an “anti-misuse” mechanism for controlling the tension of the “top tether” strap, not described). In another embodiment, that does not have such an “anti-misuse” mechanism, it can be considered to have the proximal end in rotation on a fixed axis.

The seat base described according to a first embodiment in FIG. 6 is shown integrated into the general structure of the car seat in FIG. 7. An alternative embodiment of this seat base 30 is shown in FIG. 8. The general shape of this alternative seat base remains substantially triangular but has a more extended surface.

These two approaches are in particular suited for implementing means (not shown) for controlling the tension of the “top tether” strap and/or of the tension of the latter, mounted respectively on the seat back and on the seat base.

Two connection clips 309, 310, for example of the ISOFIX type, shown in FIG. 8, make it possible to attach the car seat to anchoring points provided for this purpose in the bench seat of the motor vehicle.

According to an embodiment, these clips 309, 310 are rotatably mounted around the axis 306, independently of one another.

These clips can be stowed, when they are not being used, in locations 214, 215 provided for this purpose in the low end of the risers 201, 202 of the seat back structure. These locations 214, 215 are shown in FIGS. 2, 4 and 9A and 9B.

In their position of use, the clips 309, 310 are connected to the anchoring elements of the vehicle, while still remaining mobile in rotation with respect to the risers of the seat back. These independent movements allow, in case of impact, for a better dissipation of the energy, in particular in cooperation with the shape of the structure of the seat back and of the seat base.

More precisely, in this embodiment, connecting clips 309, 310, for example of the ISOFIX type, make it possible to attach the car seat to anchoring points provided for this purpose in the bench seat of the motor vehicle. These clips are mounted around the axis of rotation of the seat base with respect to the seat back, in elements provided for this purpose in the low end of the risers 201, 202 of the seat back structure. These elements have an inverted U profile and are pierced laterally with holes suited for receiving the axis of rotation of the seat base and of the clips.

The clips 309, 310 have an anchoring hook 311 that connects to the anchoring elements provided in the vehicle, with this hook being mobile in rotation with respect to the clip body. The upper portion of the hook 311 is linked to a spring 312, itself linked to a fork 313 mobile in translation.

In their position of use, the clips 309, 310 are connected to the anchoring elements of the vehicle, while still remaining mobile in rotation with respect to the risers 201, 202 of the seat back. These independent movements allows for a better dissipation of the energy in the event of a collision, in particular in cooperation with the shape of the seat back structure and of the seat base structure.

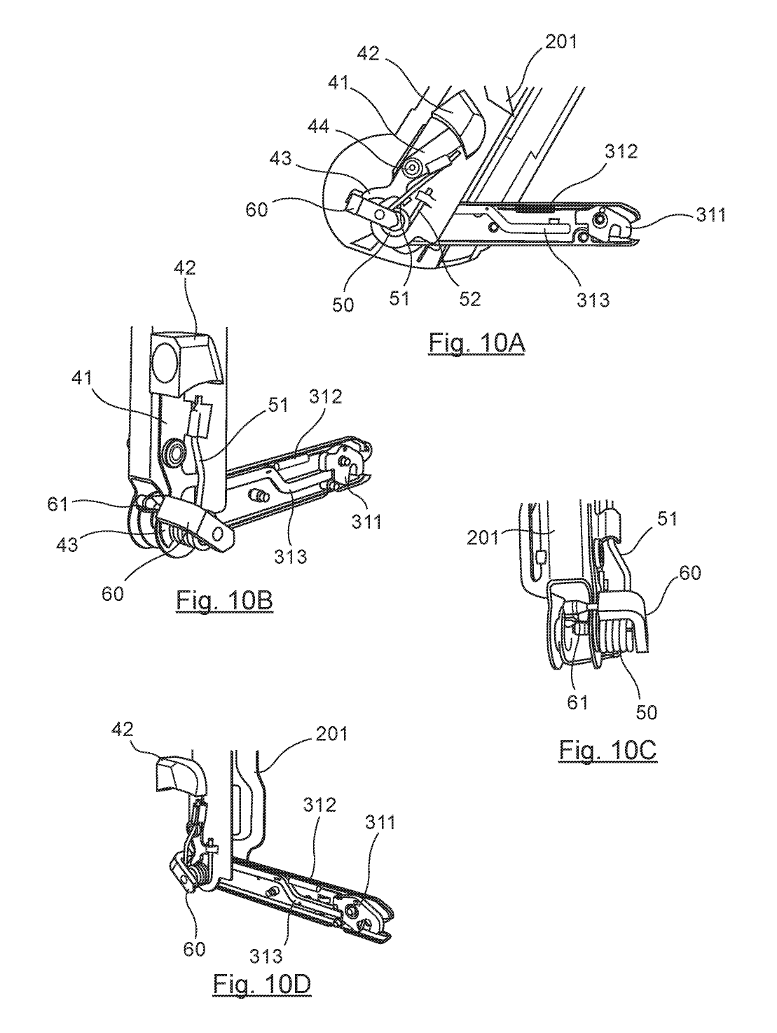

A system for unlocking is provided in the low end of each one of the risers 201, 202 of the seat back structure, as shown in FIGS. 10A to 10D. This system comprises:
a control for unlocking comprising an arm 41, a first end of which, oriented towards the top of the riser, is provided with a block 42, and a second end of which, oriented towards the bottom of the riser, comprises a free portion 43. This arm 41 is linked in rotation to the riser 201 via a pivot connection 44;
a spring 50 comprising two rods 51, 52, with a first rod 51 being connected to the first end of the arm of the control for unlocking, with a second rod 52 being fixed to the riser 201 of the seat back structure;
a locking indicator 60, mounted through a cylindrical joint on the axis of the spring at a first of its ends, and provided with a rod 61 at a second of its ends. This rod 61 is pivotably connected with the fork 313 controlling the rotation of the anchoring hook 311 of the clip 309, via the spring 312.

The operation of the system is therefore as follows: in position of use, the clips 309, 310 are fastened to the anchoring points of the vehicle, with the controls for unlocking being aligned vertically with the risers 201, 202, as shown in FIGS. 10B, 10C and 10D. When a user wants to unlock the clips 309, 310 in order to move the car seat for example, the user acts on the block 42 and thus lowers the arm 41 of the control for unlocking. The arm 41, in rotation with respect to the riser 201, actuates the locking indicator 60 by the intermediary of the free portion thereof 43. The indicator 60, through its motion, acts in turn on the fork 313, which when translating acts on the spring 312, which pivots the anchoring hook 311 upwards. The clips can then be removed from the anchoring locations of the vehicle.

The arm 41 of the control for locking, as it is lowered, exerts a force on the first rod 51 of the spring 50, with the latter being maintained fixedly with respect to the riser 201 of the seat back thanks to its second rod 52. Thus, the arm 41 naturally returns to its initial position when the user releases the pressure.

These clips can be folded back up then maintained in position in housings provided at the rear of the seat back of the seat. This characteristic makes it possible to limit the volume of the seat when it is not used, and thus facilitate its transport and storage.

Note that this particular solution of Isofix clips can, entirely or partially, be implemented on other types of car seats, in particular in non-foldable car seats.

This method for storing clips, and the fact that they can be deployed independently of one another, facilitates the installation, in particular in the case of a foldable seat (in which the installation of the clips is carried out when the seat is still folded). The mobility in rotation of the clips and of the seat base furthermore allows for an adaptation of the car seat as close as possible to the seat bench of the vehicle.

The axis 306 of reception provides the connection between the seat base and the seat back of the seat and the mobility in rotation in relation to one another. It makes it possible in particular to displace in rotation the seat base 12 in relation to the seat back 11.

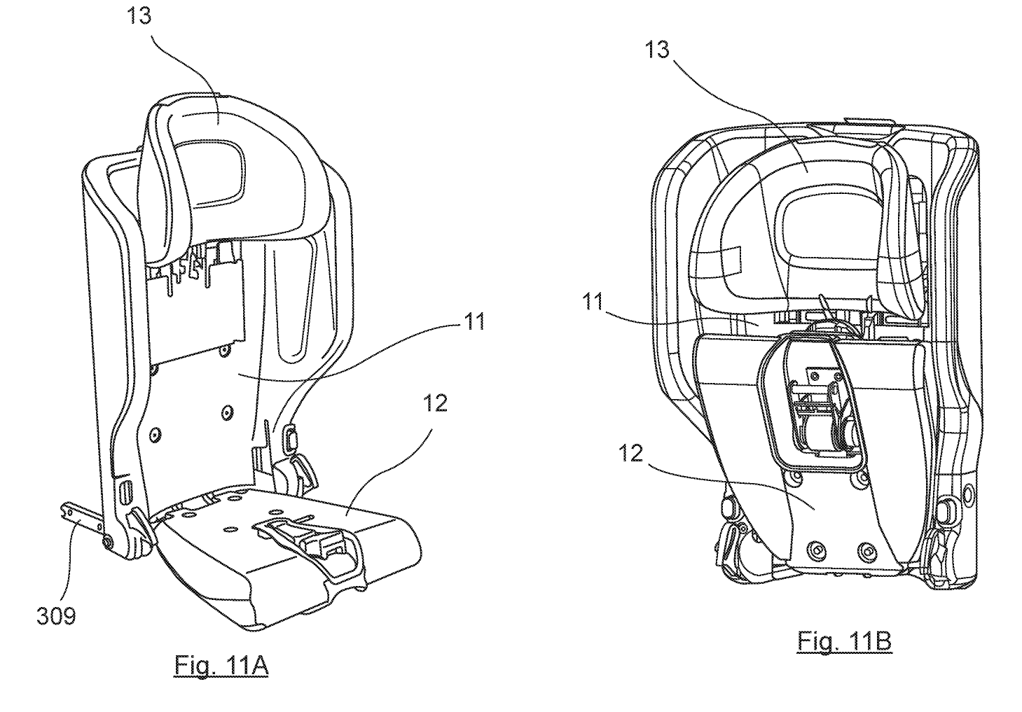

FIGS. 11A and 11B show the two positions that the car seat can have according to the embodiment described. Thus, the car seat can have a first unfolded position (FIG. 11A), wherein the seat base 12 is moved away from the seat back 11 in such a way as to install a child in the seat, and a second folded back position (FIG. 11B), wherein the seat base 12 is brought back against the seat back 11, in order to form a compact unit.

The folded position of the car seat allows the latter to be easily transported, transferred from one vehicle to another, or stored in the case of non-use. The possibility of folding back the seat combined with the gain in weight on the seat, through its seat back and seat base structures in the shape of an A, plays a preponderant role in the comfort of use of the seat.

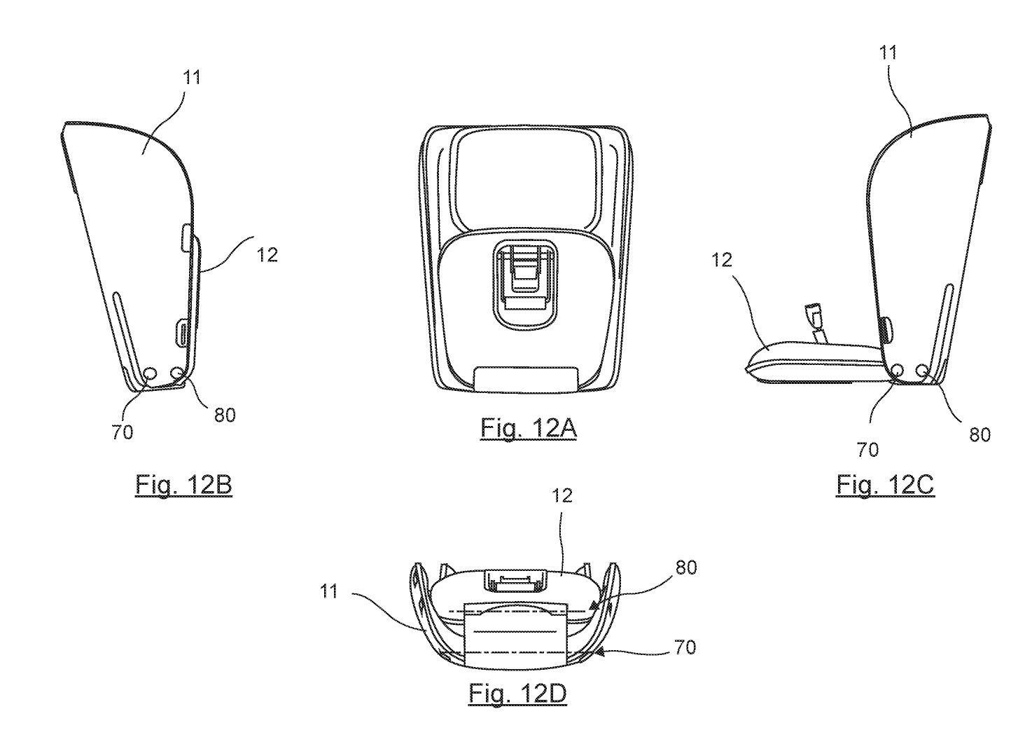

An alternative embodiment of the articulation of the car seat is shown in FIGS. 12A, 12B, 12C and 12D. In this alternative, the axis of rotation of the seat base 70 in relation to the seat back is independent of the axis of articulation of the connecting clips 80 with the seat back. The axis of rotation of the clips 50 is identical to the axis of rotation 306 of the embodiment described hereinabove while the axis of rotation of the seat base is offset in the vicinity of the front face of the seat back. This offsetting of the seat base towards the front makes it possible to optimise the passing from the unfolded position to the folded back position of the seat, and/or to offer better comfort to the child, by making it possible to provide a seat base that is thicker in the vicinity of the seat back and/or a seat back that is thicker in the vicinity of the seat base.

Although this invention has been described in reference to the particular embodiments shown, the latter is in no way limited by these embodiments, but is limited only by the annexed claims. Note that changes or modifications can be made by those skilled in the art.

1. Child car seat comprising a seat base and a seat back
characterised in that the seat back has a rigid seat back structure of which the width at its top is less than the width of its base, a lower portion of the seat back structure being recessed between lateral uprights, the lower portion extending over a height that represents between one-third and two-thirds of the total height of the seat back structure and an upper portion of the seat back structure having two holes for passing a harness strap.

2. Car seat according to claim 1, characterised in that the seat back structure has the general shape of an A, of which the lateral uprights come close to one another, from the base of the seat back to its upper end.

3. Car seat according to any of claims 1 and 2, characterised in that the upper portion extends over a height that represents between one-third and two-thirds of a total height of the seat back.

4. Car seat according to claim 1, characterised in that the rigid seat back structure is formed from two lateral units, each comprising one of the lateral uprights and one of the holes for passing a harness strap, made integral by at least one reinforcing element.

5. Car seat according to claim 4, characterised in that the rigid seat back structure comprises two reinforcing elements, respectively at an upper end and at a lower end of the upper portion.

6. Car seat according to any of claims 4 and 5, characterised in that at least one of the reinforcing elements guide and/or retain a fastening strap, allowing for the attaching of an upper portion of the seat back with an anchoring point provided for this purpose in a vehicle.

7. Car seat according to claim 1, characterised in that each one of the lateral uprights carries, at its lower end, an anchoring element of one of the harness straps.

8. Car seat according to claim 1, characterised in that the seat base has a rigid seat base structure in the general shape of an A, of which the lateral edges come close to one another, from its proximal end, close to the seat back to its distal end, arranged to extend away from the seat back

9. Car seat according to claim 8, characterised in that the rigid seat base structure defines a substantially triangular shape, recessed inside, with the distal end defining a zone for anchoring a crotch support and/or a top-tether strap idler.

10. Car seat according to any of claims 8 and 9, characterised in that the proximal end of the rigid seat base structure is included between the lower ends of the lateral edges of the rigid seat back structure.

11. Car seat according to claim 1, characterised in that the rigid seat back structure and/or rigid seat base structure is made at least in part from stamped sheet metal.

12. Car seat according to claim 1, characterised in that the seat base and the seat back can have a folded position, in which the seat base is brought back against the seat back in order to form a compact unit, and an unfolded position, in which a child can be installed in said seat.

13. Car seat according to claim 12, characterised in that the proximal end of the rigid seat base structure is mounted on an axis extending between the lower ends of the lateral edges of the rigid seat back structure.

14. Car seat according to claim 1, characterised in that two clips for connecting to locations provided for this purpose in the vehicle are movably mounted in rotation at the base of the seat back independently of one another.

15. Car seat according to claim 1, characterised in that two clips (for connecting to locations provided for this purpose in the vehicle are movably mounted at the base of the seat back between a deployed position, allowing said connection, and a storage position, in a housing provided for this purpose in the seat back.
